(19) United States
(12) Patent Application Publication
(10) Pub. No.: US 2025/0065670 A1
(43) Pub. Date: Feb. 27, 2025

(54) WHEEL ASSEMBLY

(71) Applicants: Hyundai Motor Company, Seoul (KR); Kia Corporation, Seoul (KR)

(72) Inventors: Jeong In Seo, Uiwang (KR); Ki Ho Yum, Seoul (KR); Myoung Kyu Seo, Suwon (KR)

(21) Appl. No.: 18/510,271

(22) Filed: Nov. 15, 2023

(30) Foreign Application Priority Data
Aug. 21, 2023 (KR) 10-2023-0108842

(51) Int. Cl. B60B 21/02

(52) U.S. Cl. CPC B60B 21/021; B60B 2900/211

(57) ABSTRACT

Disclosed is a wheel assembly including a wheel portion, and optionally, a hub portion transmitting driving force transmitted through a drive shaft to the wheel portion. The wheel portion further includes a wheel flange portion connected to the hub portion, and the wheel flange portion includes a foreign matter discharge portion having a first discharge surface and a second discharge surface indented in different directions on an inner side surface.

### CROSS-REFERENCE TO RELATED APPLICATION(S)

This application claims under 35 U.S.C. § 119 (a) the benefit Korean Patent Application No. 10-2023-0108842 filed on Aug. 21, 2023 in the Korean Intellectual Property Office, the disclosure of which is incorporated herein by reference in its entirety.

### BACKGROUND

### Technical Field

The present disclosure relates to a wheel assembly.

### Background

The wheels of a vehicle are connected to a drive shaft and receive driving force through a hub. Additionally, the wheel and hub of the vehicle may be combined with a brake to generate braking force for the vehicle using the brake.

In this case, the wheel further includes a hubcap to prevent the drive shaft from being exposed externally. On the other hand, the joint between the hubcap and the wheel may not be completely sealed, and thus, foreign matter such as external moisture or the like may flow into the joint between the hubcap and the wheel.

Accordingly, a foreign matter discharge passage is formed in the inner side of the wheel to discharge incoming foreign matter according to the related art.

However, the foreign matter discharge passage according to the related art depends on the shape of the wheel and has thus a problem in that the rigidity of the wheel is reduced, thereby deteriorating the noise, vibration, harshness (NVH) performance of the vehicle.

### SUMMARY

An embodiment of the present disclosure is to provide a wheel assembly in which vehicle's NVH performance may be improved by improving rigidity of a wheel, while also smoothly discharging foreign matter flowing into a hubcap.

An embodiment of the present disclosure is to provide a method of manufacturing a hub included in a wheel assembly that may smoothly discharge foreign matter flowing into a hubcap while improving NVH performance of the vehicle by improving rigidity of the wheel.

According to an embodiment of the present disclosure, a wheel assembly includes a wheel portion, and optionally, a hub portion transmitting driving force transmitted through a drive shaft to the wheel portion. The wheel portion further includes a wheel flange portion connected to the hub portion, and the wheel flange portion includes a foreign matter discharge portion having a first discharge surface and a second discharge surface indented in different directions on an inner side surface.

The wheel flange portion may further include a hubcap coupling portion connected to a hubcap, the first discharge surface may be provided along the inner side surface of the wheel flange portion, and the second discharge surface may be provided along an inner side surface of the hubcap coupling portion.

The second discharge surface may be provided with a predetermined slope with respect to the inner side surface of the hubcap coupling portion.

The predetermined slope may have an angle of about 8 degrees (°) to about 45 degrees (°) relative to the inner side surface of the hubcap coupling portion.

The wheel assembly may further include a brake disc portion disposed between the wheel portion and the hub portion, and a starting height of the second discharge surface may be set based on a surface facing the wheel portion of the brake disc portion.

The hub portion may include a disk guide portion having a cylindrical shape protruding to one side, and the disk guide portion may include a third discharge surface formed by indenting an outer circumferential surface of the one side.

The wheel assembly may further include a brake disc portion disposed between the wheel portion and the hub portion, and a starting height of the third discharge surface may be set based on a surface facing the wheel portion of the brake disc portion.

The third discharge surface may be provided in a position facing the foreign matter discharge portion.

The third discharge surface may have a width corresponding to a width of the foreign matter discharge portion.

The foreign matter discharge portion and the third discharge surface may form a foreign matter movement path through which foreign matter passes.

According to an embodiment of the present disclosure, a wheel assembly includes a wheel portion including a wheel flange portion having a foreign matter discharge portion provided by indenting an inner side surface, optionally, a brake disc portion connected to the wheel portion and transmitting braking force, and a hub portion connected to the wheel portion and including a disk support portion supporting the brake disk portion. The hub portion has a discharge surface formed by being indented in a position corresponding to the foreign matter discharge portion.

Positions of the foreign matter discharge portion and the discharge surface may be set based on a position of a coupling hole.

The coupling hole may be formed in the wheel portion, the brake disk portion, and the hub portion, respectively, and the wheel portion, the brake disk portion, and the hub portion may be connected using a coupling bolt penetrating through the coupling hole.

The foreign matter discharge portion may be formed in a number corresponding to that of the coupling hole.

The foreign matter discharge portion may include a first discharge surface formed in a circumferential direction of the wheel portion and a second discharge surface formed in an axial direction.

A starting height of the second discharge surface and a starting height of the discharge surface may be set based on a surface facing the wheel portion of the brake disc portion.

The discharge surface may be formed by forging using an annular mold.

The discharge surface may adjust a width by changing a size of a radius of the annular mold.

A width of the discharge surface may increase or decrease in proportion to an increase or decrease in a radius of the annular mold.

As discussed, the method and system suitably include use of a controller or processer.

In another embodiment, vehicles are provided that comprise an apparatus as disclosed herein.

### BRIEF DESCRIPTION OF DRAWINGS

The above and other embodiments, features, and advantages of the present disclosure will be more clearly understood from the following detailed description, taken in conjunction with the accompanying drawings, in which:

FIG. 1 is a perspective cross-sectional view of a wheel assembly according to an embodiment;

FIG. 2 is a side cross-sectional view of a wheel assembly according to an embodiment;

FIG. 3 is an enlarged view of a wheel assembly illustrating a movement path of foreign matter introduced through a hubcap according to an embodiment;

FIG. 4 is a side cross-sectional view of a wheel portion according to an embodiment;

FIG. 5 is a perspective view of a wheel flange portion viewed from the inner side according to an embodiment;

FIG. 6 is a perspective cross-sectional view of a wheel flange portion according to an embodiment;

FIG. 7 is an enlarged view of a foreign matter discharge portion formed by a wheel, brake disc, and hub assembly according to an embodiment;

FIG. 8A is a perspective view of a foreign matter discharge portion according to the related art;

FIG. 8B is a perspective view of a foreign matter discharge portion according to an embodiment of the present disclosure;

FIG. 9 is a perspective view of a hub portion according to an embodiment;

FIG. 10 is a side cross-sectional view of the hub portion according to an embodiment;

FIG. 11 is a plan view of the hub portion according to an embodiment;

FIG. 12A is a plan view illustrating an annular mold for forming the hub portion and a third discharge surface according to an embodiment, by way of example; and

FIG. 12B is a side view illustrating an annular mold for forming the hub portion and the third discharge surface according to an embodiment, by way of example.

### DETAILED DESCRIPTION

Since the present disclosure may make various changes and have various embodiments, some embodiments are illustrated in the drawings and described in detail. However, this is not intended to limit the present disclosure to the embodiments, and should be understood to include all modifications, equivalents, and substitutes included in the spirit and scope of the present disclosure.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

Terms such as first and second may be used to describe various components, but the components should not be limited by the terms. These terms are only used for distinguishing one component from another. For example, a first element may be termed a second element, and similarly, a second element may be termed a first element, without departing from the scope of the present disclosure. The term ‘and/or’ includes a combination of a plurality of related recited items or any one of a plurality of related recited items.

Terms used in this application are only used to describe embodiments, and are not intended to limit the present disclosure. Singular expressions include plural expressions unless the context clearly dictates otherwise. In this application, the terms “include”, “have” and the like are intended to designate that there is a feature, number, step, operation, component, part, or combination thereof described in the specification, but it should be understood that it does not preclude the possibility of the presence or addition of one or more other features, numbers, steps, operations, components, parts, or combinations thereof.

Unless defined otherwise, all terms used herein, including technical or scientific terms, have the same meaning as commonly understood by one of ordinary skill in the art to which the present disclosure belongs. Terms such as those defined in commonly used dictionaries should be interpreted as having a meaning consistent with the meaning in the context of the related art, and unless expressly defined in this application, it is not to be construed in an ideal or overly formal sense.

Hereinafter, with reference to the accompanying drawings, embodiments of the present disclosure will be described in more detail.

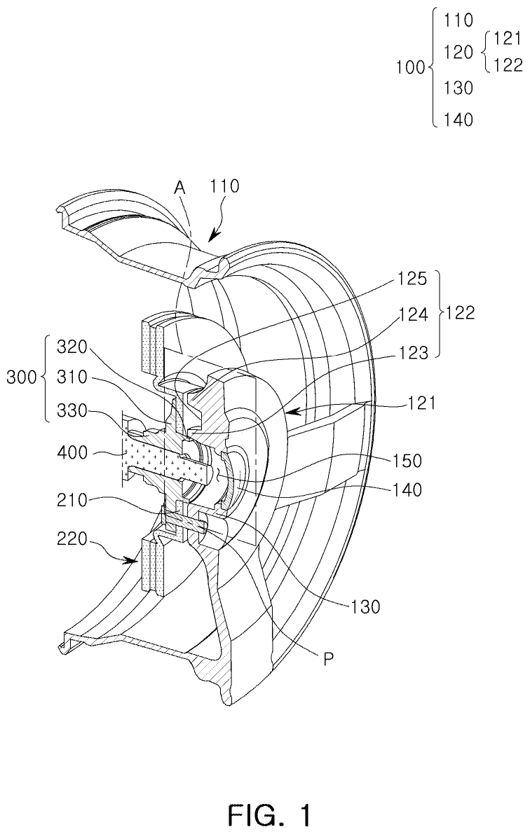

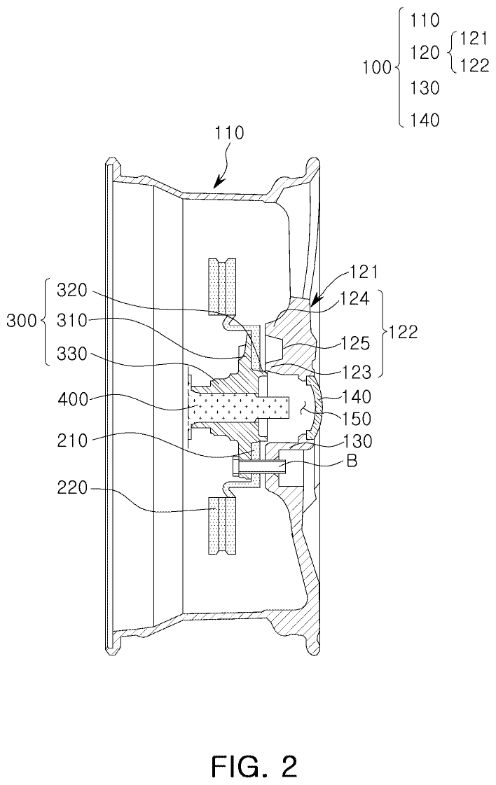

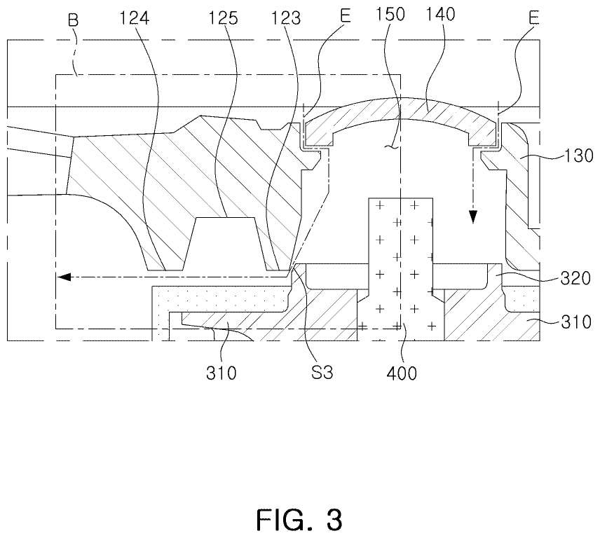

FIG. 1 is a perspective cross-sectional view of a wheel assembly according to an embodiment, FIG. 2 is a side cross-sectional view of a wheel assembly according to an embodiment, and FIG. 3 is an enlarged view of a wheel assembly illustrating a movement path (E) of foreign matter introduced through a hubcap 140 according to an embodiment.

Referring to FIGS. 1 and 2, a wheel assembly according to an embodiment may include a wheel portion 100, a brake disk portion 200, and a hub portion 300. In the wheel assembly, the brake disc portion 200 is disposed between the wheel portion 100 and the hub portion 300, and the wheel portion 100, the brake disc portion 200, and the hub portion 300 are coupled by a coupling bolt (B) penetrating therethrough.

For example, the wheel portion 100, the brake disc portion 200, and the hub portion 300 may respectively include coupling holes formed in corresponding positions, and may be coupled to each other through the coupling bolt (B) passing through the coupling holes formed in corresponding positions.

The wheel portion 100 may include a rim portion 110 supporting a tire, and a wheel disc portion 120 having an outer circumferential surface coupled to the rim portion 110 and supported thereby, and coupled to the brake disc portion 200 and the hub portion 300.

In this case, the wheel portion 100 may be integrally formed by welding the inner peripheral surface of the rim portion 110 and the outer peripheral surface of the wheel disk portion 120.

The wheel disk portion 120 may have a hub hole 150 disposed in the center. The hub hole 150 may be formed by a cylindrical hubcap coupling portion 130 protruding from the center of the wheel disk portion 120 to one side.

In this case, a drive shaft 400 may protrude from the hub hole 150 formed by the hubcap coupling portion 130. By combining the hubcap coupling portion 130 with the hubcap 140, the drive shaft 400 protruding from the hub hole 150 may be prevented from being exposed externally.

The brake disc portion 200 may include a brake flange portion 210 and a sliding portion 220.

The brake flange portion 210 is coupled to the drive shaft 400 by the coupling bolt (B) and is coupled to the hub portion 300 that rotates, and the sliding portion 220 has a disk-shaped disk structure and may generate braking force by frictionally contacting a brake pad (not illustrated).

In more detail, the sliding portion 220 of the brake disc portion 200 is disposed between a pair of brake pads (not illustrated) provided in the vehicle, and when the brake pad (not illustrated) moves toward the sliding portion 220 of the brake disc portion and contacts and presses the same, frictional force is generated between the brake pad (not illustrated) and the sliding portion 220, thereby slowing down or stopping the rotational speed of the wheel portion 100 and the hub portion 300 combined with the flange portion of the brake disc portion 200.

The hub portion 300 may include a hub flange portion 310 that is fixed and supported together with the brake disk portion 200 and the wheel portion 100 through the coupling bolt (B), a disk guide portion 320 having a hollow cylindrical shape and inserted into and supported by the brake flange portion 210, and a body portion 330 having a hollow cylindrical shape and coupled to the drive shaft 400 therein.

On the other hand, referring to FIG. 3, foreign matter such as moisture and the like may pass through the coupling portion of the hubcap coupling portion 130 and the hubcap 140. Foreign matter flowing in through the hubcap coupling portion 130 may cause corrosion. Accordingly, foreign matter that has entered the coupling portion of the hubcap coupling portion 130 and the hubcap 140 is discharged to the outside of the wheel by centrifugal force generated by the rotation of the wheel.

In more detail, foreign matter introduced into the coupling portion of the hubcap coupling portion 130 and the hubcap 140 may pass through the space formed by the inner side surface of the cylindrical hubcap coupling portion 130 of the wheel portion 100 and the outer side surface of the guide portion of the hub portion 300, and may be discharged externally through the space formed by the outer side surface F2 of the brake flange portion 210 and a foreign matter discharge portion 122 of the wheel portion 100.

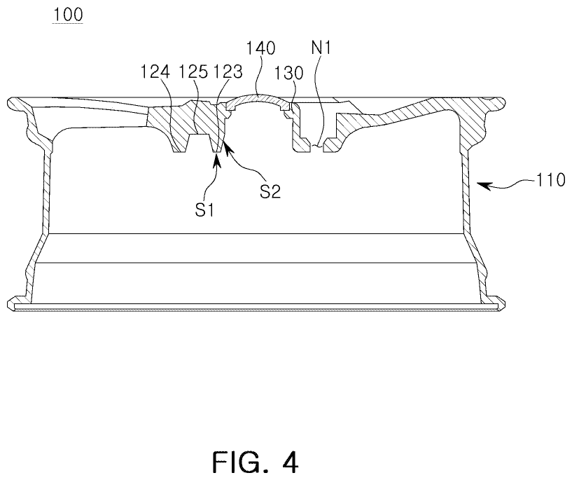

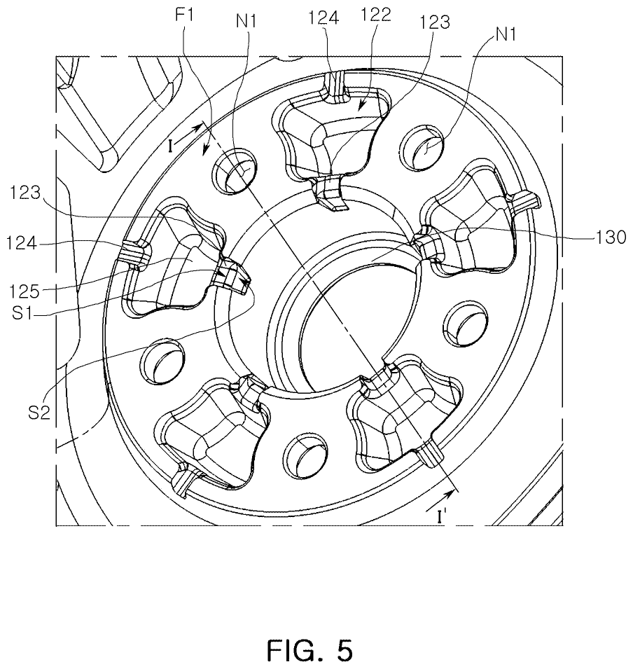

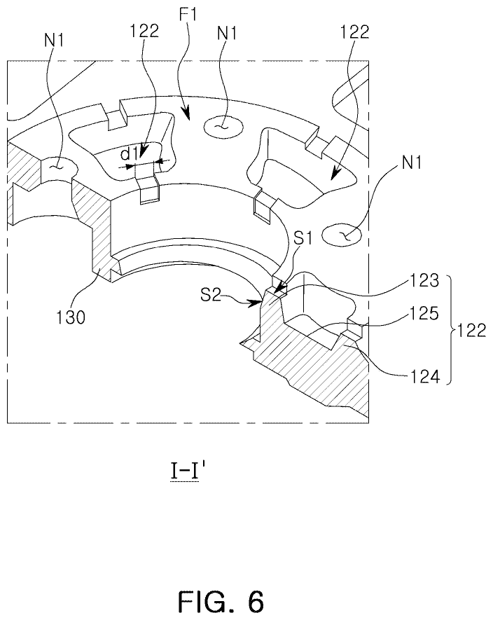

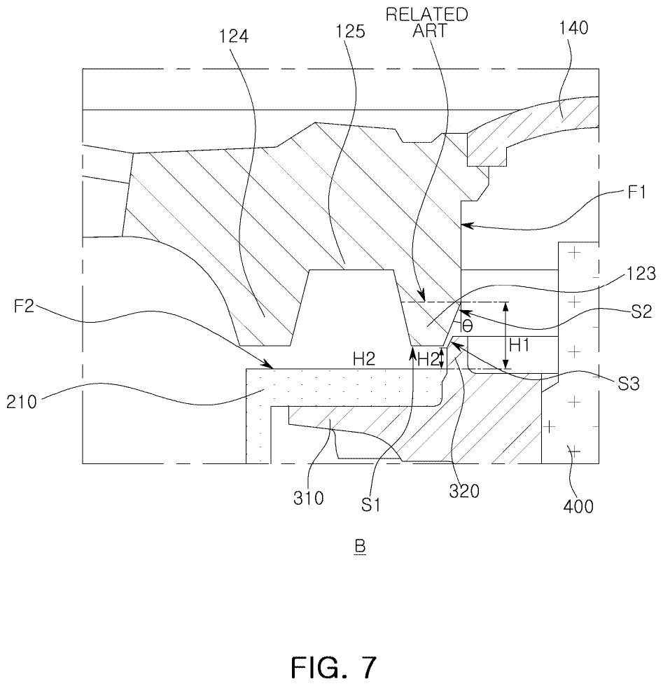

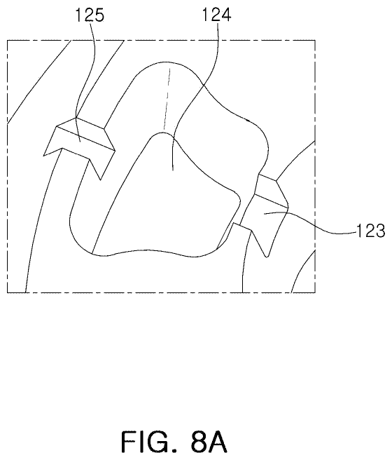

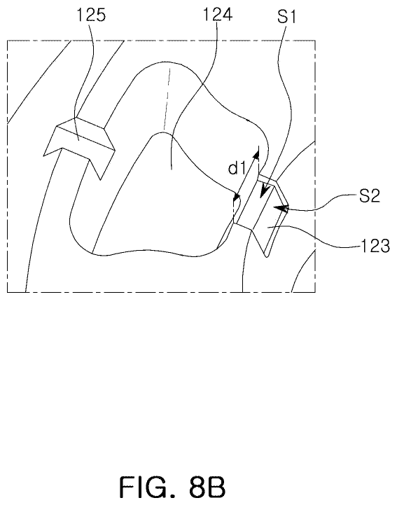

FIG. 4 is a side cross-sectional view of the wheel portion 100 according to an embodiment, FIG. 5 is a perspective view of a wheel flange portion 121 viewed from the inner side according to an embodiment, FIG. 6 is a perspective cross-sectional view of the wheel flange portion 121 according to an embodiment, and FIG. 7 is an enlarged view of the foreign matter discharge portion 122 formed by a wheel, a brake disc, and a hub assembly according to an embodiment. FIG. 8A is a perspective view of a foreign matter discharge portion 122 according to the related art, and FIG. 8B is a perspective view of the foreign matter discharge portion 122 according to an embodiment of the present disclosure.

Referring to FIGS. 4 to 6, the wheel flange portion 121 of the wheel according to an embodiment of the present disclosure may include a plurality of first coupling holes N1 penetrating through the wheel flange portion 121 and a foreign matter discharge portion 122 formed on the inner side surface of the wheel flange portion 121.

In this case, a plurality of foreign matter discharge portions 122 may be disposed between the plurality of first coupling holes N1, and the first coupling holes (N1) may have a cross-sectional shape that is indented from the outside to the inside, and the foreign matter discharge portion 122 may have a cross-sectional shape that is indented from the inside to the outside.

The first coupling hole (N1) may be formed by penetrating through the inner side and outer side surfaces of the wheel flange portion 121, and the plurality of first coupling holes N1 may be formed to be spaced apart from each other at equal intervals while forming a circle along the center of the wheel flange portion 121.

The foreign matter discharge portion 122 may form a space for discharging foreign matter introduced into the space between the hubcap 140 and the hubcap coupling portion 130 to the outside of the wheel assembly.

The foreign matter discharge portion 122 may be formed on the inner side surface of the wheel flange portion 121, and may be formed in the space between the first coupling holes (N1), which are spaced apart from each other at equal intervals and are disposed while forming a circle along the center of the flange portion.

The wheel flange portion 121 may be indented from the outer side to the inner side in the position where the first coupling hole N1 is formed, and may be formed by indenting from the inner side to the outer side in the location where the foreign matter discharge portion 122 is formed.

The foreign matter discharge portion 122 may include a first outlet 123, a foreign matter discharge groove 125, and a second outlet 124 formed by being recessed from the inner side of the wheel flange portion 121 toward the outer side.

Additionally, the first outlet 123, the foreign matter discharge groove 125, and the second outlet 124 may be connected to each other. Foreign matter flowing into the space between the hubcap 140 and the hubcap coupling portion 130 may be discharged externally by centrifugal force generated by the rotational force of the wheel along the first outlet 123, the foreign matter discharge groove 125, and the second outlet 124 that are formed by indenting from the inner side to the outer side of the wheel flange portion 121.

The first outlet 123 may be formed over a portion of the hubcap coupling portion 130 and a portion of the inner side surface of the wheel flange portion 121.

In detail, the first outlet 123 may include a first discharge surface S1 and a second discharge surface S2.

The first discharge surface S1 may be formed to be substantially parallel to the inner side surface of the wheel flange portion 121. Additionally, the second discharge surface S2 may be formed on the inner side surface of the hubcap coupling portion 130 at a predetermined angle (θ).

In FIG. 7, the dotted line exemplarily illustrates a cross section of the first outlet 123 according to the related art. Referring to the dotted line portion of FIG. 7 and FIG. 8A, the first outlet 123 according to the related art forms only a first discharge surface S1 formed substantially parallel to the inner side surface of the wheel flange portion 121. In addition, the first outlet 123 according to the related art is formed to have a relatively deep depth from the inner side surface of the wheel flange portion 121 to smoothly discharge foreign matter only through the first discharge surface S1.

On the other hand, the first discharge surface S1 forming a deep depth from the inner side surface of the wheel flange portion 121 reduces the rigidity of the wheel flange portion 121, which causes a problem in that the NVH performance of the vehicle deteriorates.

Referring to FIGS. 5 to 7 and 8B, the first outlet 123 according to an embodiment of the present disclosure has a second discharge surface S2 indented into the inner side surface of the hubcap coupling portion 130 and formed with a predetermined slope, and a first discharge surface S1 formed by indenting the inner side surface of the wheel flange portion 121.

Therefore, the first outlet 123 according to an embodiment may be formed to have a higher height than a height of the first outlet 123 according to the related art, and accordingly, the rigidity of the wheel flange portion 121 is improved, and the NVH performance of the vehicle may be improved.

In addition, the second discharge surface S2 is formed with a predetermined slope by being indented in the inner side surface of the hubcap coupling portion 130 in the direction of the movement path (E) of foreign matter discharged externally by centrifugal force, thereby helping foreign matter inside the hub hole 150 to be smoothly discharged externally.

In addition, by adjusting the starting height (H1) of the second discharge surface S2, the wheel portion 100 according to an embodiment of the present disclosure may be compatible with the wheel portion 100 of the wheel, brake disc, and hub assembly according to the related art.

In this case, the starting height (H1) of the second discharge surface S2 may be formed by using the outer surface (F2) of the brake flange portion (210) so as not to interfere with the disk guide portion 320 of the hub portion 300.

For example, in the case of the first outlet 123 of a wheel according to the related art, the first outlet 123 may be formed at a distance of 12 mm from the outer side surface F2 of the brake flange portion 210.

In this case, if the starting height H1 of the second discharge surface S2 of the first outlet 123 according to an embodiment of the present disclosure is formed smaller than 12 mm based on the outer side surface (F2) of the brake flange portion 210, interference with the brake disc portion 200 or other parts may occur.

Therefore, when the starting height H1 of the second discharge surface S2 of the first outlet 123 according to an embodiment is formed to be 12 mm or more based on the outer side surface (F2) of the brake flange portion 210, which is same as the wheel portion 100 having the first outlet 123 according to the related art and may thus be compatible therewith, without interference with other parts including the brake disc portion 200.

In the wheel, brake disc and hub assembly according to the related art, even if replaced with the wheel portion 100 according to an embodiment, foreign matter such as moisture and the like flowing into the hubcap 140 through the space between the upper surfaces of the disk guide portion 320 at the starting height H1 of the second discharge surface S2 may pass more smoothly and be discharged externally.

Referring again to FIG. 7, the second discharge surface S2 may form a predetermined angle θ based on the inner side surface of the cylindrical hubcap coupling portion 130. The angle θ of the second discharge surface S2 may be formed such that the depth of the groove increases as it moves away from the hubcap coupling portion 130 from the starting point of the second discharge surface S2.

The second discharge surface S2 forming a predetermined angle θ is formed to be inclined in the direction of the centrifugal force of the foreign matter introduced through the hubcap 140, and thus, foreign matter may be discharged externally more smoothly.

In this case, the predetermined angle (θ) may be about 8 degrees (°). The wheel portion 100 may be manufactured using a casting method, and in detail, the predetermined angle may be set to be greater than about 8 degrees (°) by considering the possibility of missing the casting mold and ease of molding, but the present disclosure is not limited thereto.

Additionally, if the predetermined angle θ is formed too large, there is a risk that the rigidity of the wheel assembly may decrease and the NVH improvement effect of the vehicle may be reduced. Therefore, the predetermined angle (θ) may be set, in detail, to be smaller than about 45 degrees (°), but the present disclosure is not limited thereto.

Referring again to FIG. 8A, the first discharge portion according to the related art forms a one-dimensional passage. In more detail, the first discharge portion forms a first discharge surface S1 in the direction from the hub hole 150 to the foreign matter discharge groove 125.

Referring again to FIG. 8B, the first discharge portion according to an embodiment of the present disclosure may form a two-dimensional passage. The first discharge portion may have a first discharge surface S1 in the direction from the hub hole 150 to the foreign matter discharge groove 125, and a second discharge surface S2 formed in the direction of the inner side surface of the wheel flange portion 121.

Accordingly, the height from the bottom of the foreign matter discharge groove 125 to the first discharge surface S1 according to an embodiment of the present disclosure may be higher than the height from the bottom of the foreign matter discharge groove 125 to the first discharge surface S1 according to the related art. In the wheel portion 100 according to an embodiment of the present disclosure, due to the material filled to the height from the bottom of the foreign matter discharge groove 125 to the first discharge surface S1, the rigidity of the wheel flange portion 121 may be strengthened to improve the NVH performance of the vehicle.

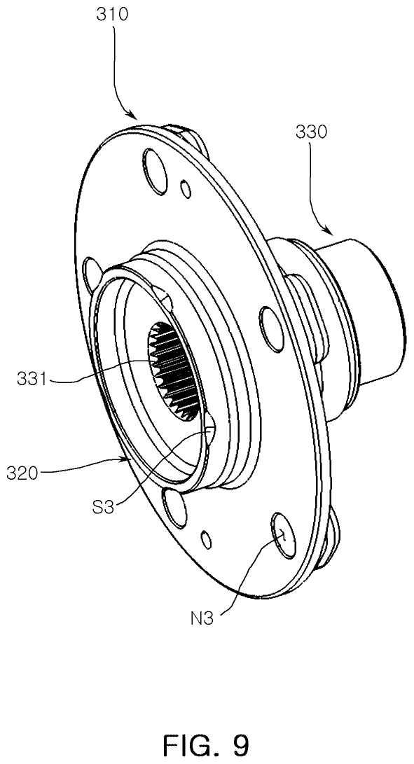

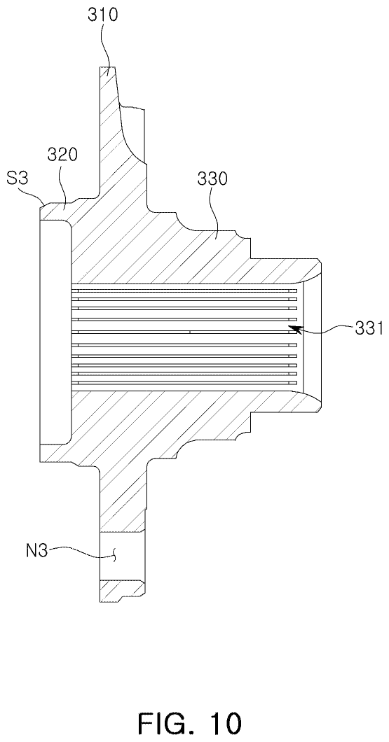

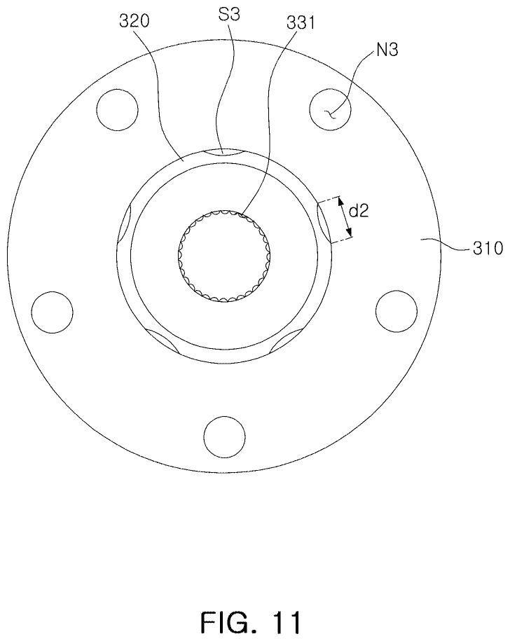

FIG. 9 is a perspective view of the hub portion 300 according to an embodiment, FIG. 10 is a side cross-sectional view of the hub portion 300 according to an embodiment, and FIG. 11 is a plan view of the hub portion 300 according to an embodiment.

Referring to FIGS. 9 to 11, in the hub portion 300 according to an embodiment, a body portion 330 of a cylindrical shape that supports the drive shaft 400 transmitting engine driving force transmitted through the transmission to the wheels, a hub flange portion 310 extending in the radial direction of the cylindrical body portion 330 and forming a third coupling hole N3, and a disc guide portion 320, which is provided on the axially outer end of the body portion 330 and into which the brake flange portion 210 of the brake disc portion 200 is inserted and supported, may be formed.

In this case, on the inner side surface of the cylindrical body portion 330, a shaft coupling portion 331 repeatedly protruding in the inner diameter direction along the longitudinal direction of the body portion 330 such that it may rotate integrally with the drive shaft 400, may further be included.

The drive shaft 400 has a cross-sectional shape corresponding to the cross-section of the cylindrical portion including the shaft coupling portion 331, and is inserted into the cylindrical portion and fixedly supported, so as not to slip, and thus, the engine driving force transmitted through the transmission may be transmitted to the wheels.

The disk guide portion 320 may further include a plurality of third discharge surfaces S3 formed along the outer circumferential surface at one end.

Referring again to FIG. 7, as the disk guide portion 320 further includes the third discharge surface S3, the movement path (E) of the incoming foreign matter may secure sufficient space for the foreign matter to pass through, and foreign matter may be smoothly discharged externally.

In this case, the third discharge surface S3 of the disk guide portion 320 may be formed to correspond to the position of the foreign matter discharge portion 122 of the wheel portion 100, in more detail, the first outlet 123.

As the first outlet 123 and the third discharge surface S3 face each other, the space of the movement path E of foreign matter may be further expanded.

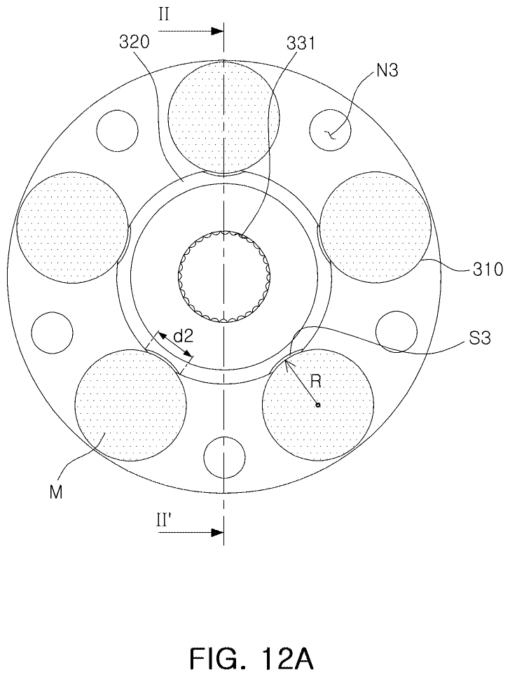

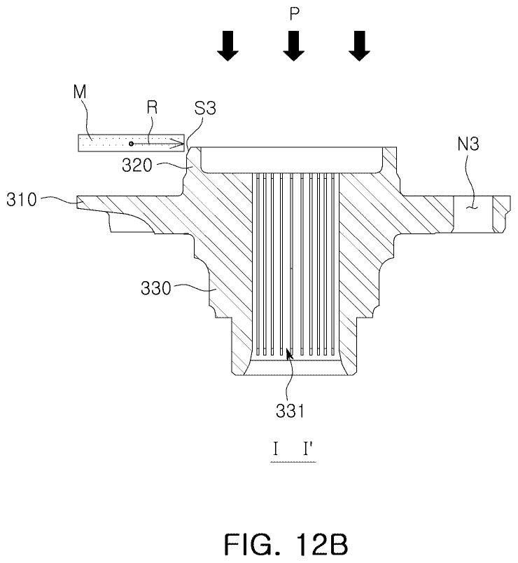

FIG. 12A is a plan view illustrating an annular mold (M) for forming the hub portion 300 and the third discharge surface S3 according to an embodiment, by way of example, and FIG. 12B is a side view illustrating an annular mold (M) for forming the hub portion 300 and the third discharge surface S3 according to an embodiment, by way of example.

A wheel assembly according to an embodiment may be assembled by the first coupling hole (N1) of the wheel portion 100, the second coupling hole (N2) of the brake disc portion 200, the third coupling hole (N3) of the hub portion 300, and the coupling bolt (B) penetrating through the first to third coupling holes N1 to N3.

Accordingly, as the foreign matter discharge portion 122 of the wheel portion 100 and the third discharge surface S3 of the hub portion 300 are aligned based on the respective coupling holes formed in corresponding positions, the foreign matter discharge portion 122 and the third discharge surface S3 may be formed in positions corresponding to each other, and a movement path (E) for foreign matter may be formed such that foreign matter may be discharged smoothly.

Referring to FIGS. 5, 9, 11, and 12A, the first coupling holes (N1), the second coupling holes (N2), and the third coupling holes (N3) may be formed in five, respectively, but the present disclosure is not limited thereto.

The wheel portion 100 may generally be manufactured through casting. In the case in which the wheel portion 100 is manufactured through casting, the foreign matter discharge portion 122 of the wheel portion 100 may be formed simultaneously with the first coupling hole N1.

Therefore, in the casting operation, the wheel portion 100 may be manufactured by manufacturing an upper or lower mold that reflects the position and shape of the foreign matter coupling portion based on the first coupling hole N1.

The hub portion 300 may be manufactured using a forging process.

For example, after first manufacturing the hub portion 300 in which no coupling hole is formed through a forging process by cutting and heating the raw material, the coupling hole may be processed by heat treatment, shorting, and the like.

In this case, referring to FIGS. 12A and 12B, the third discharge surface S3 may be formed using an annular mold.

After disposing the annular mold (M) according to the position of the foreign matter discharge portion 122, the third discharge surface S3 may be formed by pressing the annular mold (M) using a forging press (P).

For example, by disposing five annular molds M to form the same angle from the center of the hub, the third discharge surface S3 may be formed according to the position of the foreign matter discharge portion 122 of the wheel portion 100.

In this case, when the positions of the foreign matter discharge portion 122 and the third discharge surface S3 are determined based on the positions of the first to third coupling holes N1, N2, and N3, the foreign matter discharge portion 122 and the third discharge surface S3 may be formed in positions corresponding to each other.

In the configuration in which the first to third coupling holes N1, N2 and N3 are formed, although the wheel portion 100, the brake disk portion 200, and the hub portion 300 are different from each other, since the coupling bolt penetrates through the first to third coupling holes N1, N2, and N3 to connect the wheel portion 100, the brake disk portion 200 and the hub portion 300, the positions of the first to third coupling holes may correspond to each other in the wheel portion 100, the brake disc portion 200, and the hub portion 300.

For example, when a foreign matter discharge portion 122 is formed at the exact center of the two first coupling holes and a third discharge surface S3 is formed at the exact center of the two third coupling holes (N3) connected to the two first coupling holes (N1), the foreign matter discharge portion 122 and the third discharge surface S3 may form positions corresponding to each other.

Since the wheel portion 100 is generally formed by casting, the coupling hole and the foreign matter discharge portion 122 may be formed simultaneously during the process of preparing the upper mold. On the other hand, the hub portion 300 may generally be formed by a forging process, and the third discharge surface S3 may also be formed by forging.

Therefore, for continuity of the forging process, the hub portion 300 may be formed by first forging the third discharge surface and then setting the third coupling hole (N3) based on the position of the third discharge surface (S3) and drilling the same.

However, without being limited thereto, after forging the hub portion 300, the third coupling hole (N3) is first formed by drilling, and the third discharge surface S3 may be set based on the position of the third coupling hole (N3).

Additionally, by adjusting the size of the radius (R) of the annular mold (M), a width (d2) of the third discharge surface S3 may be adjusted.

For example, when the size of the radius (R) of the annular mold (M) is increased or decreased, the width d2 of the third discharge surface S3 may increase or decrease. Accordingly, the width d2 of the third discharge surface S3 may be formed to correspond to the width d1 of the first outlet 123 by adjusting the size of the radius R of the annular mold M.

By matching the width d2 of the third discharge surface S3 and the width d1 of the first outlet 123, rigidity may be significantly increasing by securing the movement path (E) of foreign matter and also significantly reducing material loss.

Referring again to FIG. 7, the starting height (H2) of the third discharge surface S3 formed by pressing the annular mold (M) may be set based on the outer surface (F2) of the brake flange portion 210, like the second discharge surface S2 of the wheel portion 100.

For example, the starting height H2 of the third discharge surface S3 may be forged to be 5 mm based on the outer side surface F2 of the brake flange portion 210.

In this case, by setting the starting height H2 of the third discharge surface S3 and the starting height H1 of the second discharge surface S2 based on the outer side surface F2 of the brake flange portion 210, compatibility with wheel assemblies according to the related art may be improved.

For example, the height of the first outlet according to the related art may be confirmed based on the outer side surface (F2) of the brake flange portion 210, and by forming the starting height (H1) of the second discharge surface S2 according to an embodiment of the present disclosure depending on the height of the confirmed first outlet, assembly with brake discs and hubs according to the related art may be obtained.

In addition, by forming the starting height H2 of the third discharge surface S3 based on the outer side surface F2 of the brake flange portion 210, the movement path (E) of foreign matter may be sufficiently secured, and the foreign matter discharge performance may be maintained or further improved compared to the related art.

As set forth above, the wheel assembly according to an embodiment may have improved NVH performance of a vehicle by improving rigidity of the wheel.

Additionally, the wheel assembly according to an embodiment may smoothly discharge foreign matter flowing into the hubcap.

In addition, in a method of manufacturing a hub according to another embodiment, by forming a foreign matter discharge passage along with a wheel with improved rigidity, a hub helping to smoothly discharge foreign matter flowing into the hubcap while improving vehicle's NVH performance may be manufactured.

In addition, in a method of manufacturing a hub according to another embodiment, by forming a foreign matter discharge passage along with a wheel with improved rigidity, a hub helping to smoothly discharge foreign matter flowing into the hubcap while improving vehicle's NVH performance may be manufactured.

While example embodiments have been illustrated and described above, it will be apparent to those skilled in the art that modifications and variations could be made without departing from the scope of the present disclosure as defined by the appended claims.

What is claimed is:

1. A wheel assembly comprising:
a wheel portion comprising a wheel flange portion,
wherein the wheel flange portion comprises a foreign matter discharge portion having a first discharge surface and a second discharge surface indented in different directions on an inner side surface of the wheel flange portion.

2. The wheel assembly of claim 1, further comprising:
a hub portion transmitting driving force transmitted through a drive shaft to the wheel portion,
wherein the wheel flange portion is connected to the hub portion.

3. The wheel assembly of claim 1, wherein the wheel flange portion further comprises a hubcap coupling portion connected to a hubcap, and
the first discharge surface is provided along the inner side surface of the wheel flange portion, and the second discharge surface is provided along an inner side surface of the hubcap coupling portion.

4. The wheel assembly of claim 3, wherein the second discharge surface is provided with a predetermined slope with respect to the inner side surface of the hubcap coupling portion.

5. The wheel assembly of claim 4, wherein the predetermined slope has an angle of about 8 degrees (°) to about 45 degrees (°) relative to the inner side surface of the hubcap coupling portion.

6. The wheel assembly of claim 2, further comprising a brake disc portion disposed between the wheel portion and the hub portion,
wherein a starting height of the second discharge surface is set based on a surface facing the wheel portion of the brake disc portion.

7. The wheel assembly of claim 2, wherein the hub portion comprises a disk guide portion having a cylindrical shape protruding to one side,
wherein the disk guide portion comprises a third discharge surface formed by indenting an outer circumferential surface of the one side.

8. The wheel assembly of claim 7, further comprising a brake disc portion disposed between the wheel portion and the hub portion,
wherein a starting height of the third discharge surface is set based on a surface facing the wheel portion of the brake disc portion.

9. The wheel assembly of claim 7, wherein the third discharge surface is provided in a position facing the foreign matter discharge portion such that the foreign matter discharge portion and the third discharge surface form a foreign matter movement path through which a foreign matter passes.

10. The wheel assembly of claim 7, wherein the third discharge surface has a width corresponding to a width of the foreign matter discharge portion.

11. A wheel assembly comprising:
a wheel portion comprising a wheel flange portion having a foreign matter discharge portion;
a hub portion connected to the wheel portion,
wherein the hub portion has a discharge surface formed by being indented in a position corresponding to the foreign matter discharge portion.

12. The wheel assembly of claim 11, further comprising:
a brake disc portion connected to the wheel portion and transmitting braking force, wherein the hub portion comprises a disk support portion supporting the brake disk portion.

13. The wheel assembly of claim 12, wherein positions of the foreign matter discharge portion and the discharge surface are set based on a position of a coupling hole.

14. The wheel assembly of claim 13, wherein the coupling hole is formed in the wheel portion, the brake disk portion, and the hub portion, respectively, and the wheel portion, the brake disk portion, and the hub portion are connected using a coupling bolt penetrating through the coupling hole.

15. The wheel assembly of claim 13, wherein the foreign matter discharge portion is formed in a number corresponding to that of the coupling hole.

16. The wheel assembly of claim 12, wherein the foreign matter discharge portion comprises a first discharge surface formed in a circumferential direction of the wheel portion and a second discharge surface formed in an axial direction.

17. The wheel assembly of claim 16, wherein a starting height of the second discharge surface and a starting height of the discharge surface are set based on a surface facing the wheel portion of the brake disc portion.

18. The wheel assembly of claim 11, wherein the discharge surface is formed by forging using an annular mold.

19. The wheel assembly of claim 18, wherein the discharge surface adjusts a width by changing a size of a radius of the annular mold.

20. The wheel assembly of claim 18, wherein a width of the discharge surface increases or decreases in proportion to an increase or decrease in a radius of the annular mold.
